(19) United States
(12) Patent Application Publication
(10) Pub. No.: US 2009/0039800 A1
(43) Pub. Date: Feb. 12, 2009

(54) AC POWER SUPPLY SYSTEM FOR BALANCED ENERGIZATION OF A PLURALITY OF LOADS

(75) Inventor: Kengo Kimura, Saitama (JP)

Correspondence Address: WOODCOCK WASHBURN LLP, CIRA CENTRE, 12TH FLOOR, 2929 ARCH STREET, PHILADELPHIA, PA, 19104-2891, US

(73) Assignee: SANKEN ELECTRIC CO., LTD., Saitama (JP)

(21) Appl. No.: 12/186,062

(22) Filed: Aug. 5, 2008

(30) Foreign Application Priority Data
Aug. 10, 2007 (JP) 2007-209585

(51) Int. Cl. H05B 41/36

(52) U.S. Cl. 315/307

(57) ABSTRACT

A gas-discharge lamp igniter is disclosed which has a group of gas-discharge lamps, such as those for LCD backlighting, connected in parallel with one another between the pair of outputs of an AC power supply. Provided one for each lamp to be energized, current-balancing transformers have their secondary windings serially interconnected. The lamps are connected to one of the pair of outputs of the AC power supply via the respective primary windings of the current-balancing transformers and the serial connection of the secondary windings thereof.

### CROSS REFERENCE TO RELATED APPLICATIONS

This application claims priority to Japanese Patent Application No. 2007-209585, filed Aug. 10, 2007.

### BACKGROUND OF THE INVENTION

This invention relates generally to electrical power supplies, and more particularly to a power supply system for feeding a plurality of loads such for example as electric-discharge lamps or gas-discharge lamps, featuring provisions for automatically balancing the currents fed to such loads.

Gas-discharge lamps such as cold-cathode fluorescent lamps (CCFLs) find extensive use for liquid crystal display (LCD) backlighting and other applications. Such lamps are lit up by an igniter incorporating a high frequency inverter, as disclosed in Japanese Unexamined Patent Publication No. 5-242987.

Built to the same stringent manufacturing specifications, the individual gas-discharge lamps might nevertheless differ in impedance and so incur an unequal flow of current therethrough. The result, in the case of LCD backlights, would be uneven display screen brightness. Japanese Unexamined Patent Publication No. 11-238589 represents a conventional remedy (shown in FIG. 1 of the drawings attached hereto) for this problem. It teaches a gas-discharge lamp igniter wherein each two lamps are connected between the pair of output terminals of an AC power supply via a pair of windings, respectively of one current-balancing transformer. Each pair of current-balancing transformer windings are interconnected, and each two pairs of current-balancing transformer windings are connected to one of the pair of output terminals of the AC power supply via an additional pair of current-balancing transformer windings, respectively. In short the lamps are energized under cascade control of the current-balancing transformers. Each pair of current-balancing transformer windings are oppositely polarized.

All such current-balancing transformers used in the gas-discharge lamp igniter are not free from some inherent fluctuations in performance. These performance fluctuations, be they ever so slight in individual transformers, become aggravated as the balancing of the lamp energization is sought to be attained by cascade connection of current-balancing transformers as in the prior art cited above. It has indeed sometimes occurred for the gas-discharge lamps to glow with unequal intensity for this reason.

### SUMMARY OF THE INVENTION

The present invention has it as an object to accomplish a well balanced energization of a plurality of loads without any such aggravation of fluctuations in transformer performance resulting from the conventional cascade connection of current-balancing transformers.

Briefly, the invention may be summarized as an AC power supply system for balanced energization of a plurality of loads as typified by gas-discharge lamps. Included is AC power supply means having a pair of outputs to be connected to each of the loads. Provided one for each load, a plurality of current-balancing transformers have each a primary winding and a secondary winding electromagnetically coupled together. The secondary windings of the current-balancing transformers are serially connected to one another. The loads to be jointly energized are to be connected between the pair of outputs of the AC power supply means via the respective primary windings of the current-balancing transformers and the serial connection of the secondary windings thereof.

Assuming that all the gas-discharge lamps have the same impedance, the lamp currents flowing through the respective lamps will be of the same magnitude. It is the sum of all these lamp currents that flows through the serially interconnected secondary windings of the current-balancing transformers. The ratio of the primary and the secondary turns of each current-balancing transformer is so predetermined that, normally, the primary and secondary circuits of each transformer are of the same ampere-turns. The magnetic fluxes generated by the primary and secondary windings counterbalance each other, permitting the flow of the same lamp current through all the lamps.

However, should any one of the lamps be higher in impedance than normal, and therefore less in the lamp current flowing therethrough, then the magnetic flux generated by the primary of the current-balancing transformer connected to that higher-impedance lamp will be less than that of the secondary of the same transformer. This difference in magnetic flux will cause a corresponding increase in the voltage across the transformer primary, causing a rise in the lamp current until it becomes balanced with the lamp currents of the other lamps.

The invention requires single-stage transformers connected in series with the respective loads to be jointly energized. Therefore, no matter how many these loads are, no aggravation of inherent fluctuations in transformer performance is to take place. A more accurately balanced energization of electric-discharge lamps or the like is thus accomplished by the invention than by the prior art having current-balancing transformers in cascade connection.

The above and other objects, features and advantages of this invention will become more apparent, and the invention itself will best be understood, from a study of the following detailed description and appended claims, with reference had to the attached drawings showing the closest prior art and some preferable embodiments of the invention.

### BRIEF DESCRIPTION OF THE DRAWINGS

FIG. 1 is a schematic electrical diagram, partly in block form, of the prior art gas-discharge lamp igniter.

FIG. 2 is a schematic electrical diagram, partly in block form, of the gas-discharge lamp igniter embodying the novel principles of this invention.

FIG. 3 is a block diagram showing in more detail the inverter control circuit of the AC power supply network in the gas-discharge lamp igniter of FIG. 2.

FIG. 4 is a schematic illustration of each of the gas-discharge lamps used with the igniter of FIG. 2.

FIG. 5 is a diagram similar to FIG. 2 but showing another preferred form of gas-discharge lamp igniter according to the invention.

FIG. 6 is a diagram similar to FIG. 2 but showing still another preferred form of gas-discharge lamp igniter according to the invention.

FIG. 7 is a diagram similar to FIG. 2 but showing a further preferred form of gas-discharge lamp igniter according to the invention.

FIG. 8 is a diagram similar to FIG. 2 but showing a still further preferred form of gas-discharge lamp igniter according to the invention.

### DETAILED DESCRIPTION

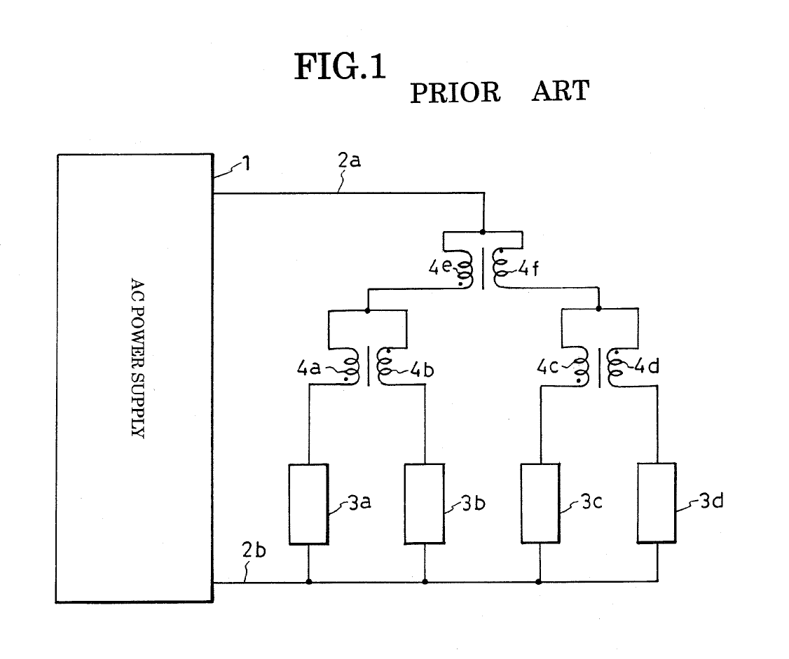

The features and advantages of the instant invention will be better understood by first briefly reconsidering the prior art gas-discharge lamp igniter proposed by Japanese Unexamined Patent Publication No. 11-238589, supra, and illustrated in FIG. 1 of the above drawings. At 1 in this figure is seen an AC power supply network comprising a rectifier circuit, an inverter circuit and a resonant circuit. A plurality of, four shown, gas-discharge lamps 3ₐ, 3_{b}, 3_{c} and 3_{d} are connected between the pair of outputs 2ₐ and 2_{b} of the AC power supply network 1. The first two gas-discharge lamps 3ₐ and 3_{d} are both connected to the power supply output 2_{b} on one hand and, on the other hand, respectively to a first pair of current-balancing transformer windings 4ₐ and 4_{b}. The other two gas-discharge lamps 3_{c} and 3_{d} are likewise connected to the power supply output 2_{b} on one hand and, on the other hand, respectively to a second pair of current-balancing transformer windings 4_{c} and 4_{d}.

The other extremities of the first pair of current-balancing transformer windings 4ₐ and 4_{b}, and those of the second pair of current-balancing transformer windings 4_{c} and 4_{d}, are connected to the power supply output 2ₐ via a third pair of current-balancing transformer windings 4ₑ and 4_{f}, respectively. As indicated by the dots in FIG. 1, each pair of transformer windings are oppositely polarized.

Thus, in event the current flowing through the first lamp 3ₐ grows less in magnitude than that of the second 3_{b}, a voltage will be induced in the winding 4ₐ in a direction to boost the current flowing through the first lamp 3ₐ. The consequent rise in the current of this first lamp 3ₐ will cause a drop in the current of the second lamp 3_{b}. The currents flowing through both lamps 3ₐ and 3_{b} will thus be balanced. The same balancing action will take place between the other two lamps 3_{c} and 3_{d}.

A current imbalance may also occur between one pair of lamps 3ₐ and 3_{b} and the other pair of lamps 3_{c} and 3_{d}. Thereupon the third pair of current-balancing transformer windings 4ₑ and 4_{f} will function in a like fashion to regain current equilibrium between the two pairs of lamps.

The problem with this type of gas-discharge lamp igniter is that no two transformers are exactly alike in performance characteristics. The performance fluctuations of each transformer tend to be added together or amplified as they are cascade connected as in this known power supply system. The balanced energization of the lamps will become even more difficult with an increase in the number of the lamps to be jointly energized and hence in that of the transformer stages.

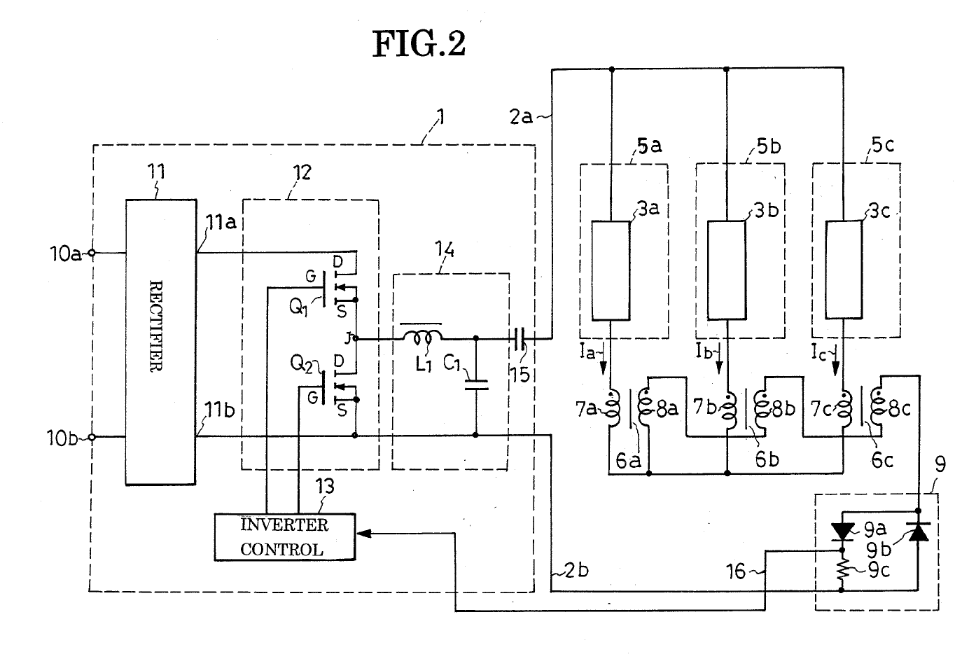

### Embodiment of FIG. 2

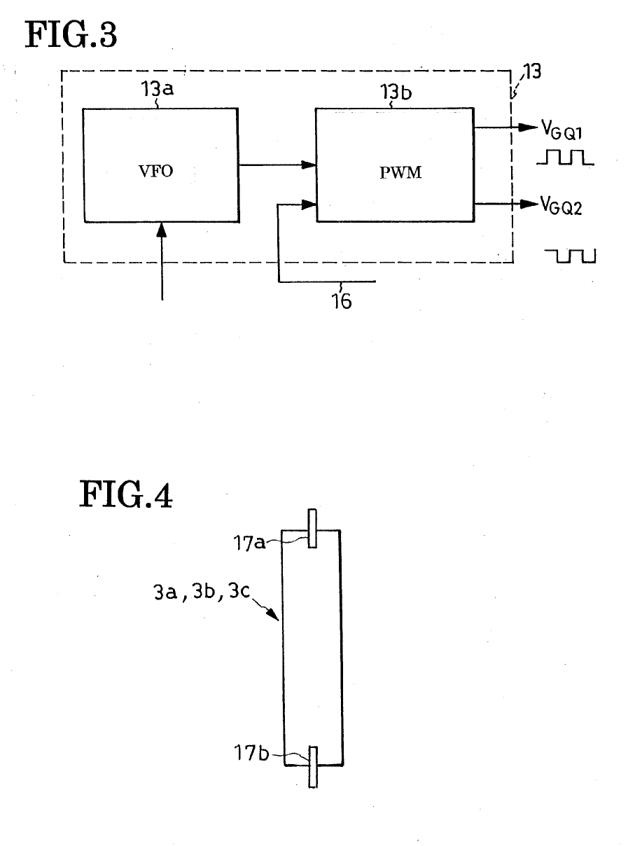

This drawback of the prior art is absent from the improved balanced power supply system of this invention schematically diagramed in its entirety in FIG. 2. Reference will also be had to FIGS. 3 and 4 in the course of the following explanation of this first embodiment of the invention. With reference to FIG. 2 the balanced power supply system according to the invention broadly comprises:

1. An AC power supply network 1 having a pair of output conductors 2ₐ and 2_{b} for energizing with lamp currents Iₐ, I_{b} and I_{c} plurality of, three shown, load circuits 5ₐ, 5_{b} and 5_{c} which include electric-discharge lamps or gas-discharge lamps 3ₐ, 3_{b} and 3_{c} in this particular embodiment of the invention.

2. Current-balancing transformers 6ₐ, 6_{b} and 6_{c} connected respectively to the gas-discharge lamps 3ₐ, 3_{b} and 3_{c} for automatically balancing the lamp currents Iₐ-I_{c}.

3. A current detector circuit 9 for maintaining the sum of the lamp currents Iₐ-I_{c} within limits by feedback control of the AC power supply network 1.

Itself of conventional make, the AC power supply network 1 comprises a rectifier circuit 11, an inverter circuit 12, an inverter control circuit 13, a resonant circuit 14, and a coupling capacitor 15. The rectifier circuit 11 is connected to a pair of AC input terminals 10ₐ and 10_{b} for translating the commercial AC voltage into a DC voltage.

The inverter circuit 12 of the AC power supply network 1 is of half-bridge construction, having two semiconductor switches Q₁ and Q₂ connected in series between the pair of outputs 11ₐ and 11_{b} of the rectifier circuit 11. The switches Q₁ and Q₂ are both shown as insulated-gate field-effect transistors (IGFETs), each having a source connected to its substrate. As is well known, each IGFET has a parasitic diode connected in parallel therewith between source S and drain D. Current flows through this parasitic diode from source S to drain D when the source is higher in potential than the drain.

Alternative constructions are possible for the IGFET switches; for example, a discrete diode might be connected reversely in parallel with each semiconductor switch. Other types of semiconductor switches are of course adoptable, such as bipolar transistors and insulated-gate bipolar transistors.

The resonant circuit 14, more commonly known as LC circuit, is a combination of an inductor L₁ and a capacitor C₁. The capacitor C₁ is connected in parallel with the second switch Q₂ of the inverter circuit 12 via the inductor L₁, although the resonant circuit 14 could be connected in parallel with the first switch Q₁. As the switches Q₁ and Q₂ go on and off, the capacitor C₁ will be charged and discharged. A sinusoidal voltage will thus develop across the capacitor C₁ and be put out over the pair of output conductors 2ₐ and 2_{b} via the coupling capacitor 15, the latter being effective to filter out the DC component from the output voltage. The coupling capacitor might be connected between the junction J of the switches Q₁ and Q₂ and the inductor L₁, instead of in the position indicated.

It is understood that the gas-discharge lamps 3ₐ-3_{c} are being used in an LCD and hence of the same voltage, current, and power ratings and the same electromechanical design. However, no matter how faithfully they are manufactured to the preordained specifications, these lamps have some fluctuations in electrical characteristics. Notably, their impedances are ordinarily not equal but differ within the given manufacturing tolerance.

While the lamps 3ₐ-3_{b} may take any of the known or suitable forms within the broad family of gas-discharge lamps, CCFLs may preferentially be adopted in the application now under consideration. As schematically pictured in FIG. 4, each CCFL has a pair of electrodes 17ₐ and 17_{b} across a hermetically sealed space.

All the lamps 3ₐ-3_{c} are connected between the pair of outputs 2ₐ and 2_{b} of the AC power supply network 1 via the current-balancing transformers 6ₐ, 6_{b} and 6_{c}, respectively, and the current detector circuit 9. The lamps 3ₐ-3_{b} are in parallel with one another.

The current-balancing transformers 6ₐ-6_{c} have primary windings 7ₐ-7_{c} and secondary windings 8ₐ-8_{c} electromagnetically coupled to each other. The transformer primaries 7ₐ-7_{c} are connected between the lamps 3ₐ-3_{c} and the second output 2_{b} of the AC power supply network 1 via the current detector circuit 9. The currents Iₐ, I_{b} and I_{c} from the lamps 3ₐ-3_{c} flow through the transformer primaries 7ₐ-7_{c}, respectively. The ratio N₁/N₂ of the numbers of turns in the primary and secondary of each of the current-balancing transformers 6ₐ-6_{c} is n/1 where n is the number of the lamps in use. Since three lamps 3ₐ-3_{c} are shown to be in use in this embodiment of the invention, the ratio N₁/N₂ here is 3/1.

The present invention proposes, for balanced energization of all the lamps 3ₐ-3_{c}, a serial connection of the secondaries 8ₐ-8_{c} of all the current-balancing transformers 6ₐ-6_{c}. Thus the first transformer secondary 8ₐ has one extremity connected to one extremity of the first transformer primary 7ₐ, the other extremity of which is connected to the first lamp 3ₐ. The second transformer secondary 8_{b} has one extremity connected to the other extremity of the first transformer secondary 8ₐ. The third transformer secondary 8_{c} has one extremity connected to the other extremity of the second transformer secondary 8_{b}. The other extremity of the third transformer secondary 8_{c} is connected to the second output 2_{b} of the AC power supply network 1 via the current detector circuit 9. As indicated by the dots in FIG. 2, the primary and secondary windings of each of the current-balancing transformers 6ₐ-6_{c} are polarized in the same direction.

An AC voltage with a frequency higher than that of the AC supply terminals 10ₐ and 10_{b} will develop between the pair of outputs 2ₐ and 2_{c} of the AC power supply network 1 when the inverter circuit 12 is conventionally driven from the inverter control circuit 13. All the gas-discharge lamps 3ₐ-3_{c} will glow when energized from the AC power supply network 1.

Let us suppose that the three lamps 3ₐ-3_{b} are all the same in impedance. Then the lamp current Iₐ, I_{b} and I_{c} flowing through these lamps will be of the same magnitude. Further, if Iₒ is the sum of the lamp currents Iₐ-I_{c}, then Iₐ=I_{b}=I_{c}=Iₒ/3. Since the ratio N₁/N₂ of the numbers of turns in the primary and secondary windings of each of the current-balancing transformers 6ₐ-6_{c} is three, the primary and secondary sides of these transformers are of the same ampere-turns. Therefore, in each current-balancing transformer, the primary and the secondary magnetic flux will exactly counterbalance each other. No additional voltage will be induced in the transformer primaries 7ₐ-7_{c}. All the lamp currents Iₐ-I_{c} are in equilibrium.

Let it now be assumed that the lamp current Iₐ energizing the first lamp 3ₐ is less than normal because of a higher impedance of that lamp, whereas the other lamps 3_{b} and 3c are being fed with normal lamp currents I_{b} and I_{c}. Then the ampere-turns N₁×Iₐ of the primary 7ₐ of the first current-balancing transformer 6ₐ will have a value less than that of the ampere-turns N₂×Iₒ of the secondary 8ₐ of the same transformer. A difference will then occur between the magnetic fluxes of the first current-balancing transformer windings 7ₐ and 8ₐ, resulting in the development of a voltage across the transformer primary 7ₐ which is added to the voltage between the pair of outputs 2ₐ and 2_{b} of the AC power supply network 1 for joint application to the first lamp 3ₐ. The lamp current Iₐ flowing through the first lamp 3ₐ will then be boosted until it grows equal to the other lamp currents I_{b} and I_{c}. Thus the three lamps 3ₐ-3_{c} will start glowing with equal intensity.

The lamp current Iₐ of the first lamp 3ₐ will be greater than normal if the impedance of the first lamp is less than normal. Then a voltage will develop across the first current-balancing transformer primary 7ₐ in a direction to lessen the voltage applied to the first lamp 3ₐ, so that the lamp current Iₐ will return to normal. It is self-evident that a similar balancing action takes place in the cases where the other lamps 3_{b} and 3_{c} are abnormally high or low in impedance.

The current detector circuit 9 as current detector means comprises two diodes 9ₐ and 9_{b} connected reversely in parallel with each other on the path of the total lamp current Iₒ, and a resistor 9_{c} connected in series with the diode 9ₐ. A total lamp current signal, a voltage indicative of the total lamp current Iₒ, is obtained across the resistor 9_{c} to be fed back over the conductor 16 to the inverter control circuit 13.

As block-diagrammatically depicted in FIG. 3, the inverter control circuit 13 comprises a variable frequency oscillator (VFO) 13ₐ and pulse width modulator (PWM) 13_{b}. The PWM 13_{b} modulates the width of the incoming VFO signal according to the total lamp current signal from the current detector circuit 9 in order to hold the total lamp current Iₒ within prescribed limits. The PWM 13_{b} supplies the first control signal V_{GQ1} to the gate of the first switch Q₁, and supplies the second control signal V_{GQ2} to the gate of the second switch Q₂. The first and second switches Q₁ and Q₂ operate on the contrary mutually.

Notwithstanding the showings of FIGS. 1 and 2, however, the feedback control of the power delivered to the lamps 3ₐ-3_{c} is not an essential feature of this invention. The current-balancing means according to the invention will be fully functional without the feedback loop.

It will be appreciated that the invention realizes a balanced energization of the lamps 3ₐ-3_{c} merely by connecting single-stage transformers 6ₐ-6_{c} in series with the respective lamps. No aggravation of fluctuations in the performance of these transformers is to takes place as they are not cascaded as in the prior art of FIG. 1. A highly reliable equalization of the lamp currents Iₐ-I_{c} is attained through the relatively simple configuration of current-balancing transformers. Such improved equalization of the lamp currents lead to improved uniformity in the brightness of the display screen. The lamps will be energized even more stably by feedback control of the output from the AC power supply network 1.

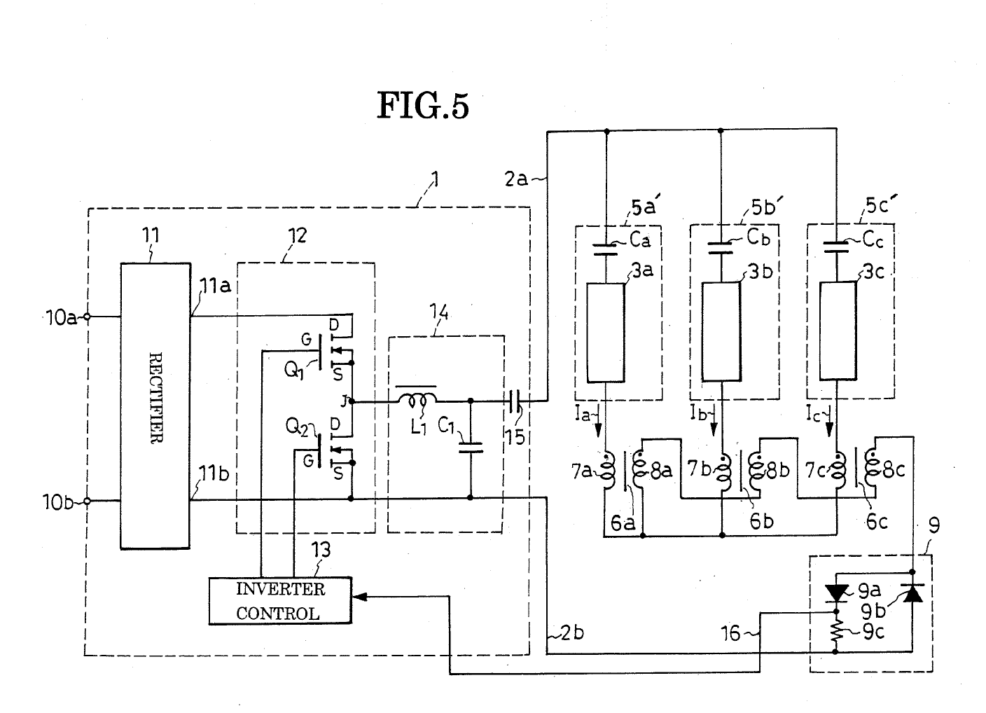

### Embodiment of FIG. 5

The gas-discharge lamp igniter shown here is of the same construction as that of FIG. 2 except for modifications in load circuits 5ₐ′, 5_{b}′ and 5_{c}′. The modified load circuits 5ₐ′-5_{c}′ incorporate ballast capacitors Cₐ, C_{b} and C_{c} connected in series with the gas-discharge lamps 3ₐ, 3_{b} and 3_{c}, respectively.

As disclosed for example in the aforementioned Japanese Unexamined Patent Publication No. 11-238589, the ballast capacitors Cₐ-C_{c} serve to boost by resonance the voltages impressed to the lamps 3ₐ-3_{c} and hence to let them glow more stably. The coupling capacitor 15 of the AC power supply network 1 may be unnecessary as the ballast capacitors Cₐ-C_{c} serve the additional purpose of eliminating the unidirectional components from the currents being fed to the lamps 3ₐ-3_{c}. Resonant circuits each comprising a serial connection of a capacitor and an inductor might be adopted in substitution for the ballast capacitors Cₐ-C_{c}.

The other benefits of this lamp igniter are as set forth above in conjunction with the embodiment of FIG. 2.

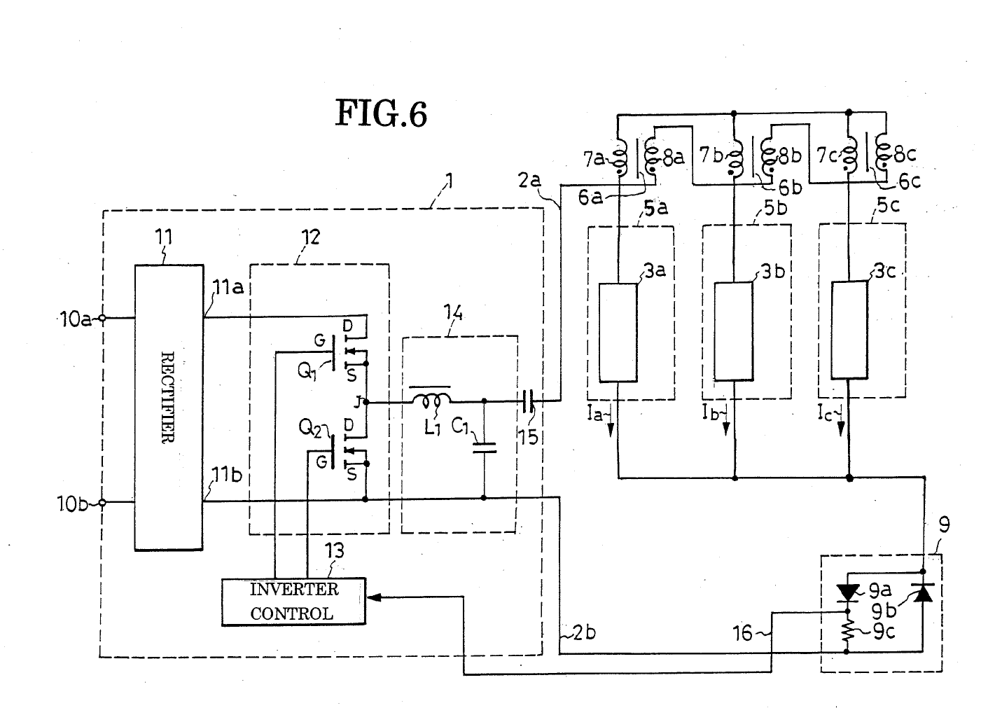

### Embodiment of FIG. 6

This embodiment differs from that of FIG. 2 only in that the current-balancing transformers 6ₐ-6_{c} are connected between the first output 2ₐ of the AC power supply network 1 and the load circuits 5ₐ-5_{c}. Thus the gas-discharge lamps 3ₐ-3_{c} are connected to the AC power supply output 2ₐ via the respective transformer primaries 7ₐ-7_{c} and the serial connection of the transformer secondaries 8ₐ-8_{c}. The lamps 3ₐ-3_{b} are connected on the other hand to the second output 2_{b} of the AC power supply network 1 via the current detector circuit 9.

Being identical with the embodiment of FIG. 2 in all the other details of construction, this embodiment gains the same advantages therewith.

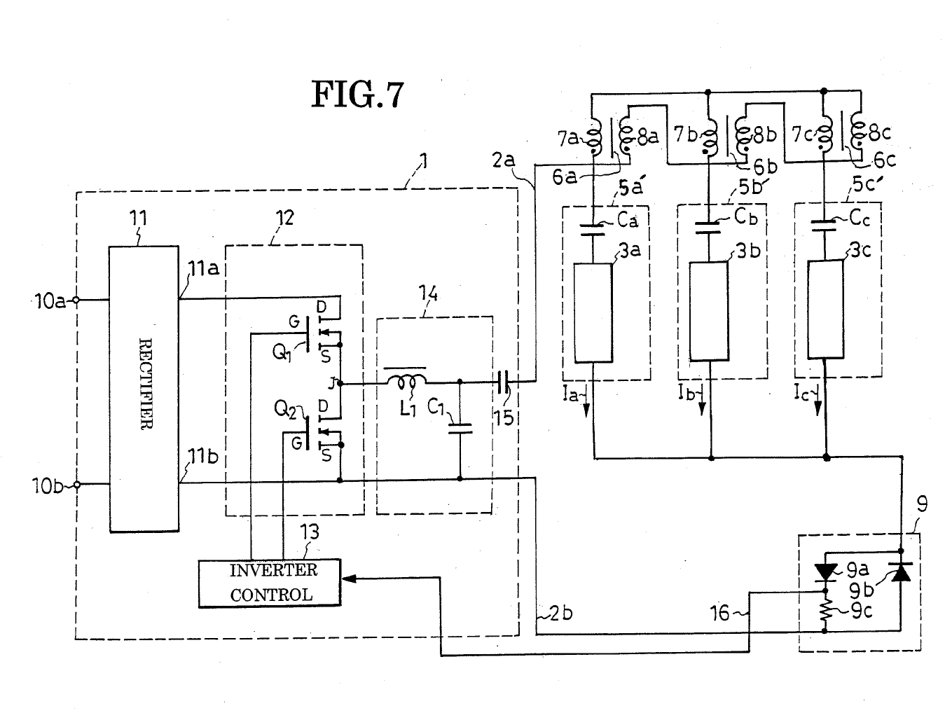

### Embodiment of FIG. 7

Here is shown a combination of the embodiments of FIGS. 5 and 6. The load circuits 5ₐ′-5_{c}′ including the ballast capacitors Cₐ-C_{c} in addition to the gas-discharge lamps 3ₐ-3_{c} as in FIG. 5 are combined with the current-balancing transformers 6ₐ-6_{c} of the same placement as those in FIG. 6. This embodiment offers all the benefits of the embodiments of FIGS. 2, 5 and 6.

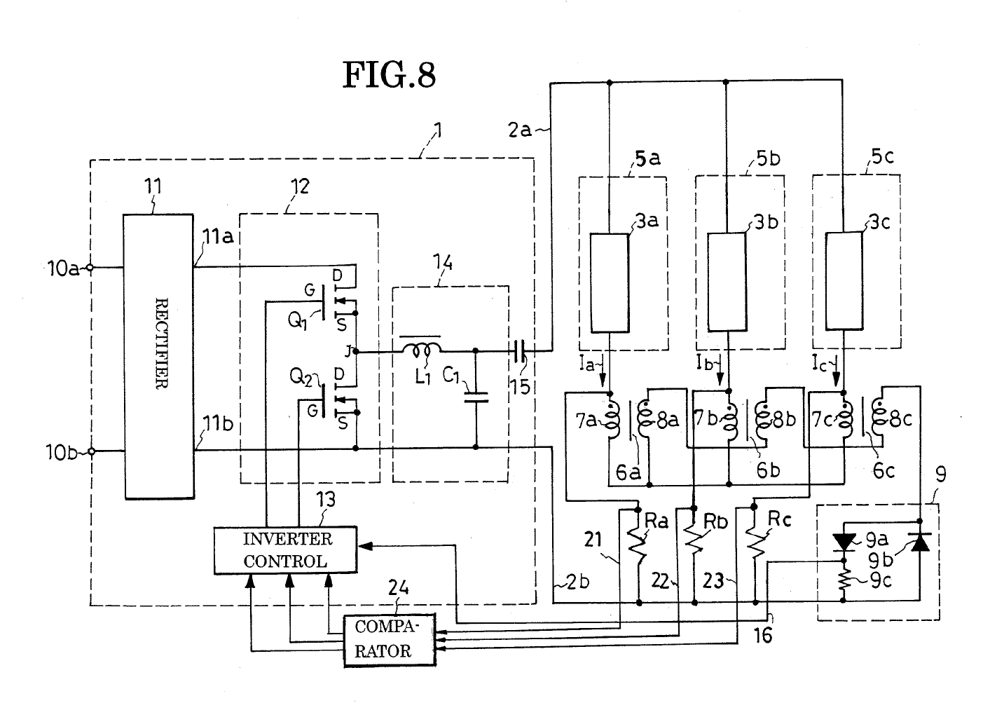

### Embodiment of FIG. 8

This embodiment features load state detector means for automatically suspending the energization of the gas-discharge lamps 3ₐ-3_{c} upon detection of any abnormal state in either of these lamps. The load state detector means include resistors Rₐ, R_{b} and R_{c} each connected on one hand to the junction between one gas-discharge lamp and one associated current-balancing transformer primary and on the other hand to the output 2_{b} of the AC power supply network 1. The resistors Rₐ-R_{c} are individually connected via conductors 21, 22 and 23 to comparator means 24 and thence to the inverter control circuit 13 of the AC power supply network 1. This embodiment is similar to that of FIG. 2 in all the other details of construction.

The resistors Rₐ-R_{c} serve to provide voltage signals indicative of the states of the respective lamps 3ₐ-3_{c}, that is, of whether these lamps are each installed or uninstalled, lit or unlit, or lit normally or abnormally, in short, of whether the respective load circuits 5ₐ-5_{c} are open or closed. Inputting these voltage signals, the comparator means 24 compares them with a reference. If any of the voltage signals is higher than the reference, the comparator means 24 causes the inverter circuit 13 to turn off the inter circuit 12.

Alternatively, the load state detector means may be connected to a selected or one ones of the current-balancing transformers instead to all the current-balancing transformers. Similar load state detector means may be added to the other gas-discharge lamp igniters disclosed herein.

### Possible Modifications

Although the balanced power supply system according to the present invention has been shown and described hereinbefore in terms of some currently preferred forms, it is not desired that the invention be limited by the exact details of these preferred forms or by the description thereof. The following is a brief list of possible modifications of the illustrated embodiments which are all believed to fall within the purview of the instant invention:

1. The invention is applicable to the balanced powering of various forms of resistance or impedance loads in addition to the exemplified gas-discharge lamps.

2. The invention is of particular utility when applied to the energization of greater numbers of loads than shown in the attached drawings.

3. The AC power supply network 1 may be of any known or suitable construction capable of providing an AC voltage. Thus, for example, the half-bridge inverter 12 is replaceable by either a full-bridge or a push-pull inverter or by an inverter of different type wherein a switch connected in series with a transformer primary is rapidly turned on and off to provide an AC voltage across the transformer secondary. The VFO 13ₐ, FIG. 3, of the inverter control circuit 13 is also replaceable by a fixed frequency oscillator.

4. The feedback control of the AC power supply network 1 is not an absolute necessity.

5. It is desirable that the gas-discharge lamps 3ₐ-3_{c} be of the same current, voltage and impedance ratings, and the transformers 6ₐ-6_{c} be also of the same ratings. However, the invention is applicable if these lamps, or the load circuits 5ₐ-5_{c} or 5ₐ′-5_{c}′, differ in impedance beyond the manufacturing tolerances. In that case the winding turns of the transformers 6ₐ-6_{c} may be readjusted for the respective load circuits.

6. The current detector circuit 9 is replaceable by a Hall generator or the like. The Hall generator or the like is coupled to one of the outputs of the AC power supply means.

What is claimed is:

1. An AC power supply system for balanced energization of a plurality of loads, comprising:
(a) AC power supply means having a pair of outputs to be connected to each of a plurality of loads to be energized;
(b) a plurality of current-balancing transformers provided one for each load and each having a primary winding and a secondary winding electromagnetically coupled together, the secondary windings of the current-balancing transformers being serially connected to one another; and
(c) means for connecting the loads between the pair of outputs of the AC power supply means via the respective primary windings of the current-balancing transformers and the serial connection of the secondary windings thereof.

2. An AC power supply system as recited in claim 1, wherein the ratio of the turns in the primary winding of each current-balancing transformer to the turns in the secondary winding thereof is n/1 where n is the number of the loads to be energized.

3. An AC power supply system as recited in claim 1, wherein the AC power supply means comprises an inverter, and a resonant circuit connected between the inverter and the pair of outputs of the AC power supply network.

4. An AC power supply system as recited in claim 3, further comprising a feedback control loop comprising:
(a) current detector means coupled to one of the outputs of the AC power supply means for detecting a current to flow through the loads; and
(b) an inverter control circuit connected between the current detector means and the inverter of the AC power supply means for controlling the current to flow through the loads in response to an output from the current detector means.

5. An AC power supply system as recited in claim 1, further comprising a load state detector circuit comprising:
(a) voltage detector means connected to at least one of the primary windings of the current-balancing transformers for providing a voltage signal indicative of the state of at least one of the loads; and
(b) comparator means for comparing the load state signal from the voltage detector means with a reference voltage.

6. A lamp igniter for balanced energization of electric lamps, comprising:
(a) AC power supply means having a pair of outputs for providing an AC supply voltage;
(b) a plurality of lamps connected in parallel with one another between the pair of outputs of the AC power supply means thereby to be energized individually; and
(c) a plurality of current-balancing transformers provided one for each lamp to be energized and each having a primary winding and a secondary winding electromagnetically coupled together, the secondary windings of the current-balancing transformers being serially connected to one another;
(d) the lamps being connected to either of the pair of outputs of the AC power supply means via the respective primary windings of the current-balancing transformers and the serial connection of the secondary windings thereof.

7. A lamp igniter as recited in claim 6, further comprising a plurality of ballast capacitors each connected in series with one of the lamps.
